(19) United States
(12) Patent Application Publication
(10) Pub. No.: US 2013/0024246 A1
(43) Pub. Date: Jan. 24, 2013

(54) EMPLOYING SOFTWARE TO MODEL ORGANIZATIONAL STRUCTURES POLICIES AND PROCESSES

(71) Applicants: Madan Natu, Redmond, WA (US); Balachandran Atur, Redmond, WA (US); Arthur Greef, Burien, WA (US); Srinivasan Parthasarathy, Redmond, WA (US); Tao Wang, Bellevue, WA (US); Ramesh Gururaja, Sammamish, WA (US); Vijay Kurup, Sammamish, WA (US); Sukumar Rathnam, Sammamish, WA (US); Angel Saenz-Badillos, Somerville, MA (US)

(72) Inventors: Madan Natu, Redmond, WA (US); Balachandran Atur, Redmond, WA (US); Arthur Greef, Burien, WA (US); Srinivasan Parthasarathy, Redmond, WA (US); Tao Wang, Bellevue, WA (US); Ramesh Gururaja, Sammamish, WA (US); Vijay Kurup, Sammamish, WA (US); Sukumar Rathnam, Sammamish, WA (US); Angel Saenz-Badillos, Somerville, MA (US)

(73) Assignee: MICROSOFT CORPORATION, Redmond, WA (US)

(21) Appl. No.: 13/185,085

(22) Filed: Jul. 18, 2011

(51) Int. Cl. G06Q 10/00

(52) U.S. Cl. 705/7.38; 705/1.1

(57) ABSTRACT

A modeling application enables consistency among business applications and among business application processes by providing internal control rules for the business applications according to an organization model. The modeling application may model the organization by structuring the organization types within the modeled organization and providing the internal control rules for deployed business applications to comply with the organization model. The internal control rules define application semantics, properties, and policies for the business applications to provide consistent functionality across the organization.

### BACKGROUND

Business applications provide a large number of powerful tools addressing many aspects of businesses and other organizations. A majority of such applications provide integrated capabilities for financial management, distribution, manufacturing, project accounting, human resources management, field service management, business analytics, and comparable areas. Integration and data maintenance is a primary goal of business applications but rarely met due to variety and complexity of domains across business and other organizations.

A prior solution to integration and data maintenance was to implement a fragmented architecture. A business application with a fragmented architecture usually provided customized components to meet the domain complexity and variety in customer requirements. Business application providers would implement customized components to meet customer specifications when off the shelf components were not sufficient to meet the deployment requirements. Cost of deployment usually increased exponentially with each customized component due to customized nature of such fragmented architectures. Reuse functionality were usually highly limited due to customized nature of the solutions which further limited return on investment. Maintenance and upkeep of the business application were also problematic for the customer information technology departments due to the customized nature of the product and potential for a need to pay for provider project teams to upkeep the business application.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to modeling organizational structures, policies and processes. A modeling application may maintain organization type configurations that define application semantics for business applications deployed or to be deployed in organizations. The modeling application may unify the organization types across application domains. The modeling application may enable users to create an organization according to one of the organization types. The modeling application may enable policies and processes in the deployed business application according to internal control rules as defined in the organization type used for creating the deployed application.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an architecture describing example organizational structures to be modeled by a modeling application according to some embodiments;

FIG. 2 illustrates example components of systems interacting with an organization model provided by the modeling application;

FIG. 3 illustrates another architecture describing organization type and components according to the modeling application;

FIG. 4 illustrates a flow diagram of the modeling application components and their functionality according to embodiments;

FIG. 5 illustrates integration with deployed application components according to embodiments;

FIG. 6 is a networked environment, where a system according to embodiments may be implemented;

FIG. 7 is a block diagram of an example computing operating environment, where embodiments may be implemented; and

FIG. 8 illustrates a logic flow diagram for a process of modeling organizational structures, policies and processes employing a modeling application according to embodiments.

### DETAILED DESCRIPTION

As briefly described above a modeling application may model organizational structures, policies and processes. Embodiments may enable a modeling application to model an organization. A modeling application may group organizations by using types of organizations such as legal entities and operating units. The modeling application may use organizations and multiple hierarchies for providing application semantics. In addition, the modeling application may use date effective versioning and may use custom operating unit types to restructure organizations for business applications. Embodiments may also enable integration with business application frameworks. The modeling application may integrate with a global address book, performance measurement dimensions, and/or data security and business policies frameworks to implement business application policies and processes. In the following detailed description, references are made to the accompanying drawings that form a part hereof, and in which are shown by way of illustrating specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a non-transitory computer-readable memory device. The computer-readable storage medium can for example be implemented via one or more of a volatile computer memory, a non-volatile memory, a hard drive, a flash drive, a floppy disk, or a compact disk, and comparable media.

According to embodiments, an organization is an accountability control point associated with individuals associated through a relationship based on employment, position, membership, and so on. An organization may be a for-profit, not-for-profit or governmental organization. An organization may comprise a group of organizations. The modeling application may define and enable business applications to inherit application semantics. Application semantics may include parameters for deployed business applications to implement business processes. An example may be reporting guidelines to implement for all business applications to produce consistently formatted reports across an organization. Additionally, the modeling application may outline policies for business applications to follow in order to implement the business applications' functionality across the organization. An application scenario may implement internal control rules to enforce functionality per the organizational requirements.

Throughout this specification, the term “platform” may be a combination of software and hardware components for a modeling application to implement policies and processes in business applications. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

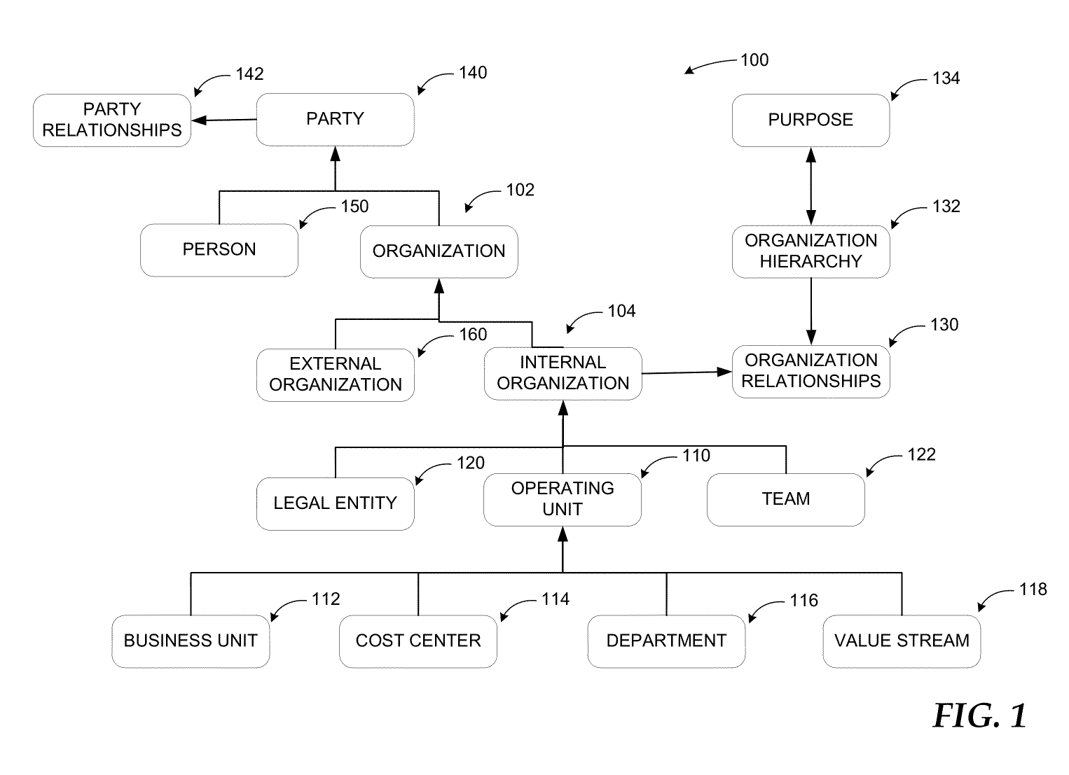

Referring to FIG. 1, diagram 100 illustrates an architecture describing example organizational structures to be modeled by a modeling application according to some embodiments. Example components shown in diagram 100 are for illustration purposes. Embodiments may be implemented in various local, networked, and similar computing environments employing a variety of computing devices and systems.

In an example architecture, as illustrated in diagram 100, a modeling application may enable users to model an organization to implement business processes and application scenarios for business applications. According to an embodiment, a person 150 may participate in a relationship with an organization 102. Both, person 150 and organization 102, may be types of a party 140 which may participate in party relationships 142 with other parties.

Additionally, the organization 102 may be an external organization 160 or an internal organization 104. The internal organization 104 may be made of organization types such as a legal entity 120, an operating unit 110, and a team 122. The legal entity may be an organization type with a registered or legislated legal structure that is granted the authority to enter into legal contracts. The legal entity may be required to prepare statements that report on its performance. The operating unit 112 may be an organization type that divides the control of economic resources and operational processes among people. The operating unit 112 may assume the roles of one or multiple units such as a business unit 112, cost center 114, a department 116, and a value stream organization 118.

The internal organization may be mapped by the modeling application through definitions found in organization relationships 130. The organization relationships 130 may reference an organization hierarchy 132 for the relationships and the purpose 134 of the organization hierarchy 132.

According to an embodiment, the modeling application may enable a user to create and manage organizations. The modeling application may provide multiple organization types which may be designed using tools such an organization hierarchy designer. The user may maintain the modeled organization through the modeling application. In an example scenario, multiple organizations may make up a party or multiple parties based on relationship definitions. Additionally, each organization may be defined as a performance measurement dimension. Furthermore, the modeling application may define policies for organizations and information system data access control policies based on the organizations.

According to other embodiments, the modeling application may enable application processes. In an example processes, the modeling application may enable procurement application processes by defining a purchase requisition. In another example scenario, the modeling application may provide human resources application processes by defining positions and employees and their relationships with organizations. In yet another example process, the modeling application may provide expense management application processes by defining how to process expense reports.

According to yet other embodiments, the modeling application may structure and extend organization models. In an example, new types of operating units may be added as required for industry specific organization concepts. Additionally, the modeling application may also restructure existing organization models. An example may be restructuring of an existing organization using date effective hierarchies due to merger and acquisition scenarios or restructuring carried out to improve processes that result in achieving and exceeding goals on performance. Embodiments are not limited to architectures according to these example configurations. The modeling application may implement organizations and units in a similar manner with other components using the principles described herein.

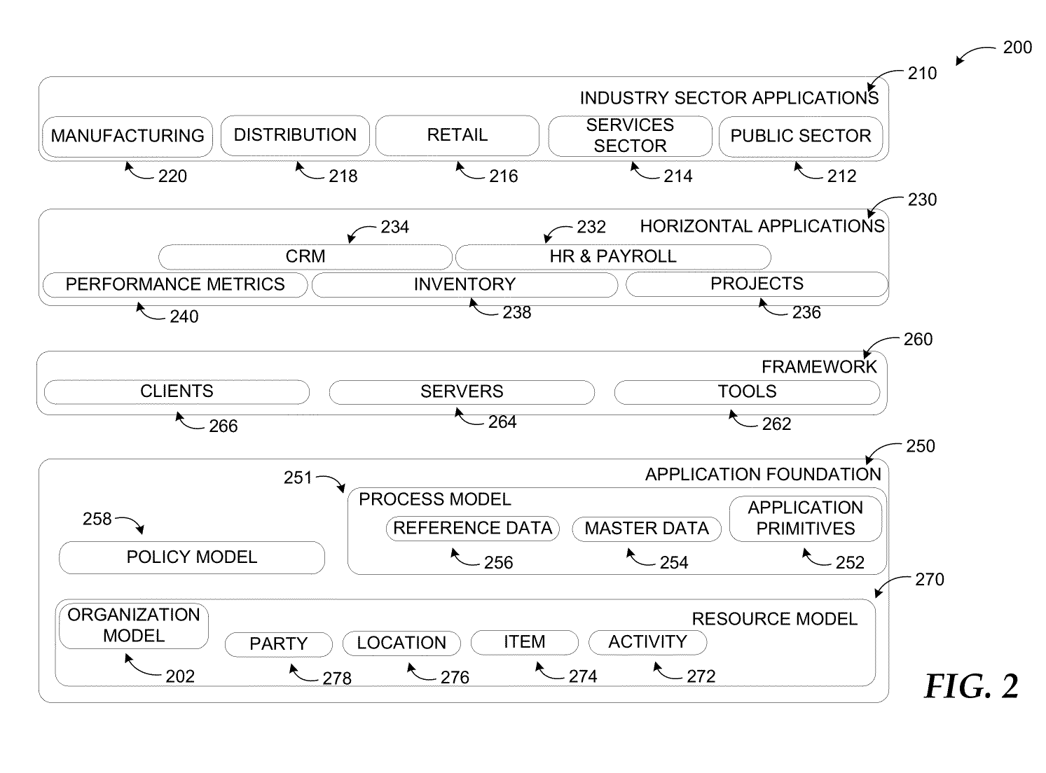

FIG. 2 illustrates example components of systems interacting with an organization model provided by the modeling application. Diagram 200 displays application types and components that may interact with the organization model 202 provided by the modeling application. Industry sector applications 210, for example, may follow organization policies and processes according to the application semantics and internal control rules provided by the organization model 202. Industry sector applications 210 may include manufacturing 220, distribution 218, retail 216, services sector 214, and public sector 212 applications.

In other embodiments, horizontal applications 230 may receive application semantics and rules per the organization model 202 during deployment. For example, restructuring processes may be transparent to horizontal applications and that may make the organization agile and responsive to change. The horizontal applications may include customer relationship management (CRM) 234, human resources (HR) & payroll 232, performance metrics 240, inventory 238, and project 236 applications.

A business application may receive parameters from the organization model 202 to configure its application foundation 250. Organization model 202 is one component of resource model 270, which may further include activity information 272, item information 274, location information 276, and/or party information 278. Resource model 270 and its components may also be part of application foundation 250, which may include policy model 258 and process model 251. The modeling application may provide internal control rules to define parameters such as application primitives 252 including data type definitions. The business application's master data 254 and reference data 256 may also be defined by the modeling application's organization model 202 according to the application semantics and internal control rules. Reference data 256, master data 254, and application primitives 252 may be part of the process model 251 within application foundation 250.

Organization model may be used to define master data and parameter data sharing rules based on organization hierarchies, and specify rules for definition of specific master data instances and their attributes and further for rules that govern defaulting and override using organization hierarchies. Master data includes entities that describe the parties, locations, products, and activities that are referenced by entities that document and record domain events. Parameter data includes entities that configure the operations of an application. Parameters control flows within processes. Master data includes key information such as customers, vendors, products, employees, and materials that may be required to run an organization and its processes and that are non-transactional in nature.

The ultimate goal of the organization model is effective management control of an organization through performance measurement, data security policies, centralized processing or shared services, master data sharing, and various policies and rules. The organization structures and application use of those organization structures according to embodiments enable that using rules, policies and processes. Integration of applications is one implementation of the organization model 202. Another use may include integration of processes within one application.

Each business application may expose a framework 260 to receive guidelines for application deployment from the organization model 202 as provided by the modeling application. The framework may provide components to guide tools 262, server components 264, and client components 266 of a business application. Other application frameworks may include, but are not limited to, a dimensions framework, a distribution framework, etc. Integration of applications is one use of the organization model. Another use according to embodiments is integration of processes within one application.

The ultimate goal of the organization model is effective management control of an organization through performance measurement, data security policies, centralized processing or shared services, master data sharing, and various policies and rules. The organization structures and application use of those organization structures enable that using rules, policies, and processes. Embodiments are not limited to systems according to these example components. The modeling application may implement organization models guiding application components in a similar manner with other values using the principles described herein.

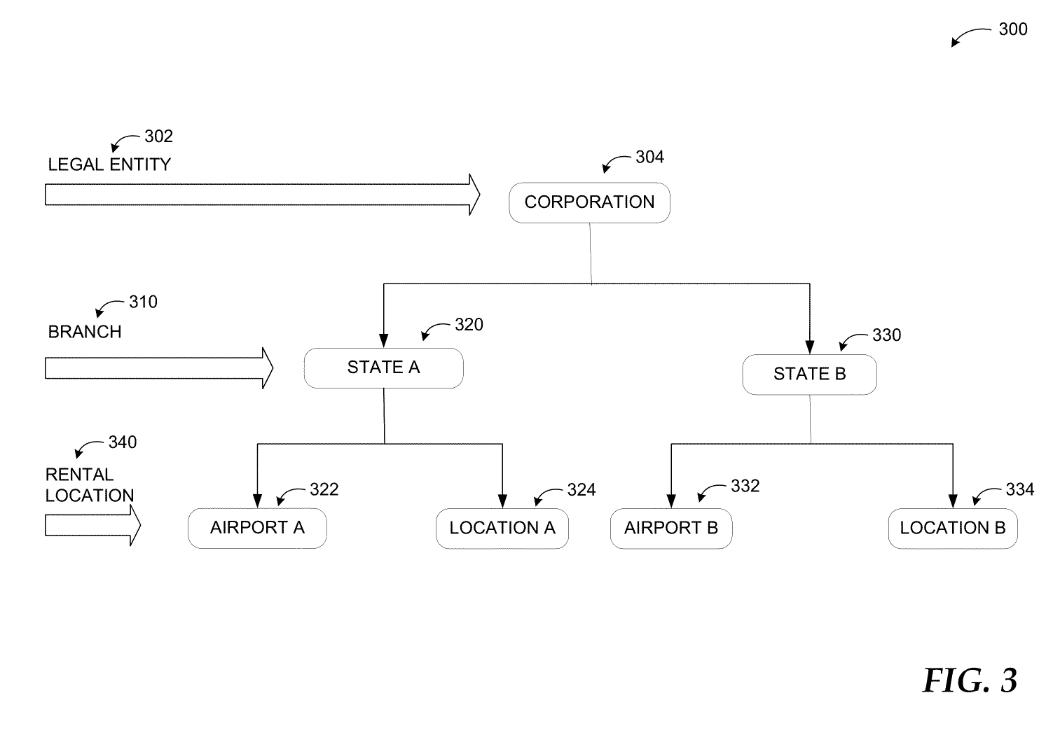

FIG. 3 illustrates another architecture describing an example organization type and components according to the modeling application. In diagram 300, corporation 304 is a legal entity 302. The modeling application may divide accountability for its economic resources among branches 310 (organizations state A 320 and state B 330) under an organization type of legal entity 302 as exemplified by the higher organization unit corporation 304. Each branch may also further divide accountability between organizational units such as rental locations 340, in an example car rental organization (or real estate). Branch entity State A 320 may divide accountability between organization units airport A 322 and location A 324. State B may divide accountability between organization units airport B 332 and location B 334.

According to an embodiment, the modeling application may divide accountability between branch entities of State A 320 and State B 330 under the organization type of legal entity 302 across application domains. Upon implementation of the organization model by the modeling application, business applications deployed in branches of State A 320 and State B 330 may provide reports rolling up according to the legal entity organization type. Default internal control rules may override existing business application parameters to provide consistency across the organizations. Modeled hierarchies may be reused to implement other branch organizations. Performance may be measured across the legal entity type organization. Data access authorization may be inherited according to rules inherited from the legal entity 302 type organization. Cost may be controlled per internal control rules inherited from the legal entity 302 type organization. Additional fraud detection rules may be implemented per definitions provided by the application semantics and internal control rules of the legal entity 302 organization type. Embodiments are not limited to unifying organization types according to these example structures. The modeling application may unify organization types according to application domains in a similar manner with other values using the principles described herein.

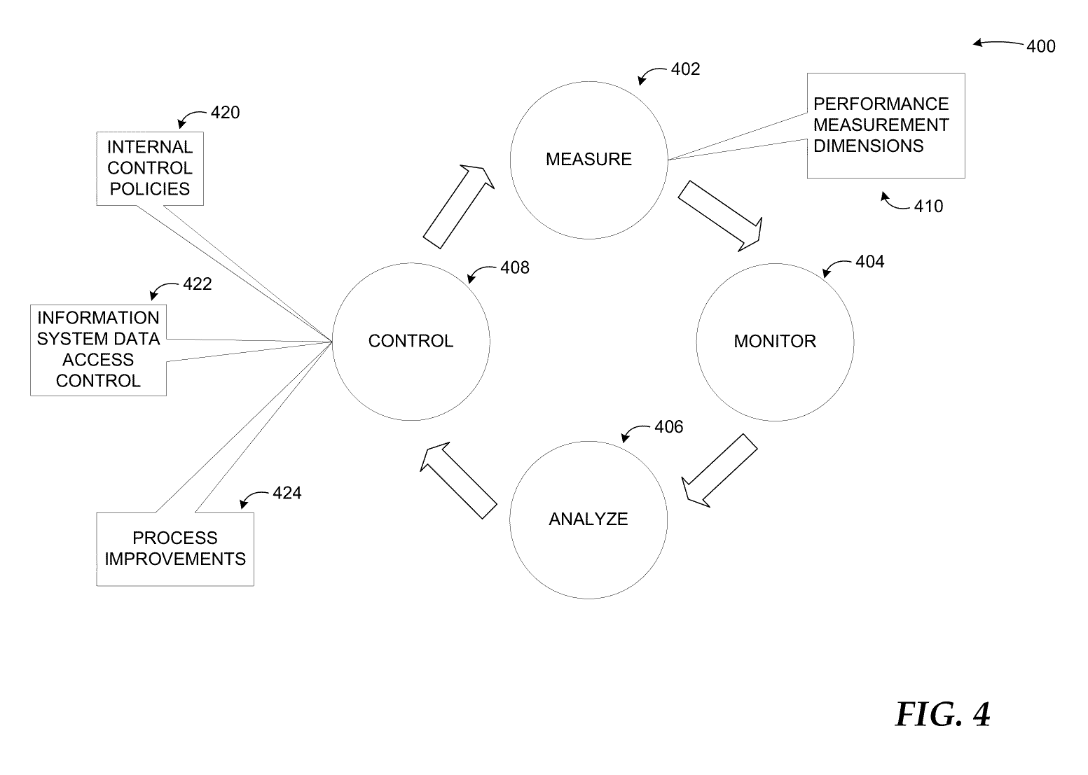

FIG. 4 illustrates a flow diagram of the modeling application components and their functionality according to embodiments. In diagram 400, the modeling application may implement multiple components in an application scenario for a deployed application according to internal control rules as defined by the organization type. The component, measure 402, may outline performance measurement dimensions 410 to be followed by the deployed or to be deployed business applications. The components, monitor 404 and analyze 406, may define application semantics and parameters for the business applications to standardize organization performance evaluation across the organization. Component, control 408, may define internal control policies 420, information system data access control policies 422, and process improvements 424 for business applications to implement.

In an embodiment, performance measurement dimensions 410 provided by the modeling application may standardize reporting by business applications across the organization. The modeling application may standardize the business applications according to the internal control rules to use shared services and centralized processing. Standardization may drive operating efficiency.

In another embodiment, internal control rules provided by the modeling application may define internal control policies 420 for the deployed business applications. The modeling application may control information systems data access control policies within the organization by enforcing access restrictions to data. The modeling application may master data management and maintenance by providing internal control rules to maintain data in the business applications. Additionally, the modeling application may define HR organization charts according to internal control rules. Embodiments are not limited to modeling application components according to these example components. The modeling application may implement components in a similar manner with other functionality using the principles described herein.

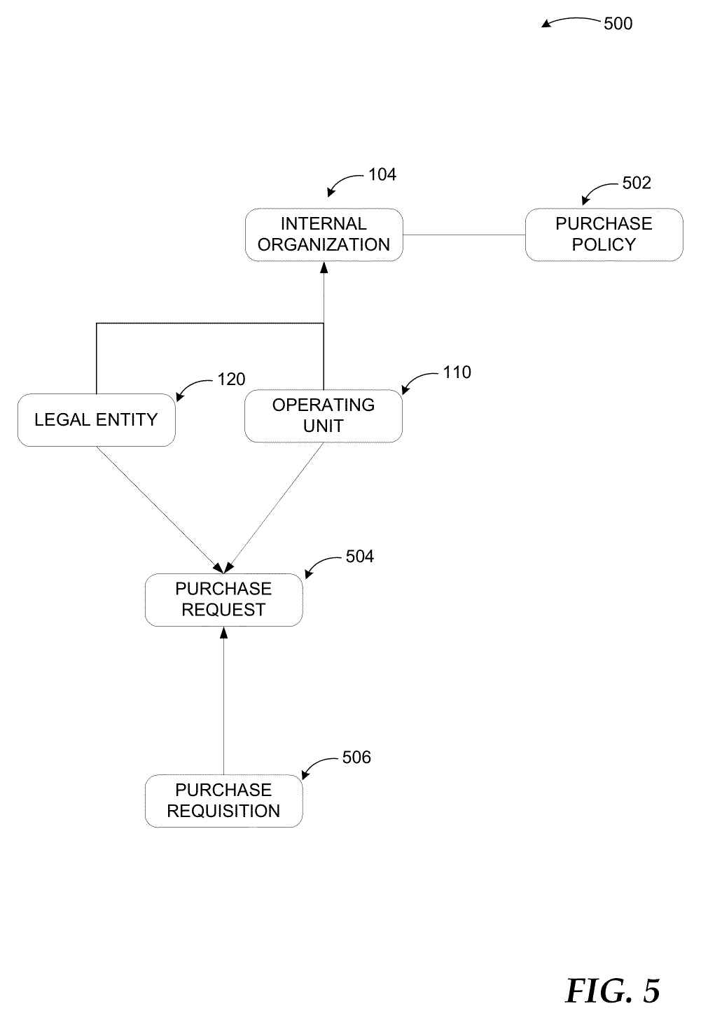

FIG. 5 illustrates integration with deployed application components according to embodiments. The example scenario displayed in diagram 500 illustrates utilization of unification across application domains. Legal entity 120 and operating unit type organizations may be united under internal organization 104 by the modeling application. The modeling application may implement a purchase policy 502 that may enable the business applications deployed in the organizations to meet internal control rules as defined by the internal organization's 104 organization type.

In the example scenario of diagram 500, legal entity 120 may be the buying entity, while operating unit 110 may be the receiving entity (for example, the corporation pays for some equipment, but a specific operating unit such as manufacturing site A receives the purchased unit). Since the purchase policy 502 is implemented in both legal entity 120 type organization and operating unit 110 type organization, the purchase request 504 may automatically integrate the roles of legal entity 120 and operating unit 110 in any purchase activity. A business application in the operating unit 110 may have already been standardized to meet the purchase request requirements as outlined by the purchase policy 502.

The example embodiments in FIG. 1 through 5 are shown with specific components and configurations. Embodiments are not limited to systems according to these example configurations. Modeling organizational scenarios and processes may be implemented in configurations employing fewer or additional components in business applications. Furthermore, the example architectures, systems and components shown in FIG. 1 through 5 and their attributes may be implemented in a similar manner with other components using the principles described herein.

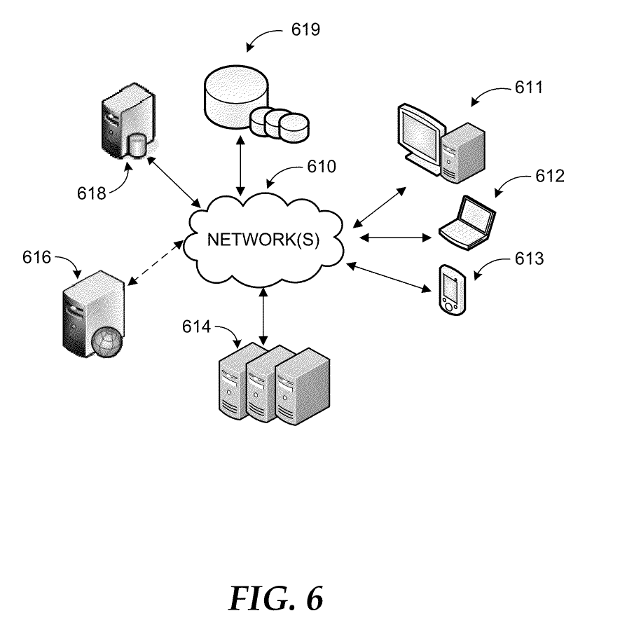

FIG. 6 is a networked environment, where a system according to embodiments may be implemented. Organization models may be automatically and manually created by a modeling application executed over one or more servers 614 or a single server (e.g. web server) 616 such as a hosted service. The modeling application may communicate with business applications on individual computing devices such as a smart phone 613, a laptop computer 612, or desktop computer 611 ('client devices') through network(s) 610.

As discussed above, the modeling application may configure organization types that define application semantics for business applications deployed or to be deployed in organizations. The modeling application may unify the organization types across application domains. The modeling application may create business applications according to one of the organization types for deployment in a matching organization and implement internal control rules per the organization type of the organization.

Client devices 611-613 may enable access to applications executed on remote server(s) (e.g. one of servers 614) as discussed previously. The server(s) may retrieve or store relevant data from/to data store(s) 619 directly or through database server 618.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to model organizations to implement organizational scenarios and processes. Furthermore, the networked environments discussed in FIG. 6 are for illustration purposes only. Embodiments are not limited to the example applications, modules, or processes.

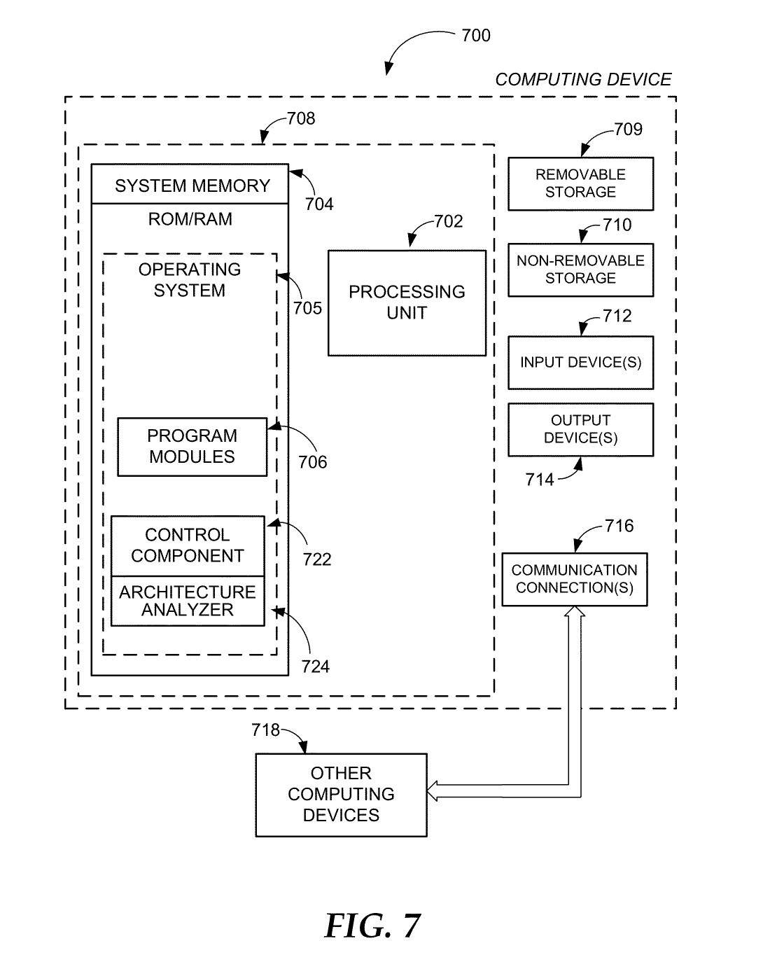

FIG. 7 and the associated discussion are intended to provide a brief, general description of a suitable computing environment in which embodiments may be implemented. With reference to FIG. 7, a block diagram of an example computing operating environment for an application according to embodiments is illustrated, such as computing device 700. In a basic configuration, computing device 700 may include at least one processing unit 702 and system memory 704. Computing device 700 may also include a plurality of processing units that cooperate in executing programs. Depending on the exact configuration and type of computing device, the system memory 704 may be volatile (such as RAM), non-volatile (such as ROM, flash memory, etc.) or some combination of the two. System memory 704 typically includes an operating system 705 suitable for controlling the operation of the platform, such as the WINDOWS® operating systems from MICROSOFT CORPORATION of Redmond, Wash. The system memory 704 may also include one or more software applications such as program modules 706, control component 722, and architecture analyzer 724.

Control component 722 may be part of a modeling application implementing internal control rules and policies to business applications deployed across an organization. The architecture analyzer 724 may determine application semantics and attributes to provide for business applications according to application scenarios and processes provided by the organization type. This basic configuration is illustrated in FIG. 7 by those components within dashed line 708.

Computing device 700 may have additional features or functionality. For example, the computing device 700 may also include additional data storage devices (removable and/or non-removable) such as, for example, magnetic disks, optical disks, or tape. Such additional storage is illustrated in FIG. 7 by removable storage 709 and non-removable storage 710. Computer readable storage media may include volatile and nonvolatile, removable and non-removable media implemented in any method or technology for storage of information, such as computer readable instructions, data structures, program modules, or other data. Computer readable storage media is a non-transitory computer readable memory device. System memory 704, removable storage 709 and non-removable storage 710 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer readable storage media may be part of computing device 700. Computing device 700 may also have input device(s) 712 such as keyboard, mouse, pen, voice input device, touch input device, and comparable input devices. Output device(s) 714 such as a display, speakers, printer, and other types of output devices may also be included. These devices are well known in the art and need not be discussed at length here.

Computing device 700 may also contain communication connections 716 that allow the device to communicate with other devices 718, such as over a wireless network in a distributed computing environment, a satellite link, a cellular link, and comparable mechanisms. Other devices 718 may include computer device(s) that execute communication applications, storage servers, and comparable devices. Communication connection(s) 716 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

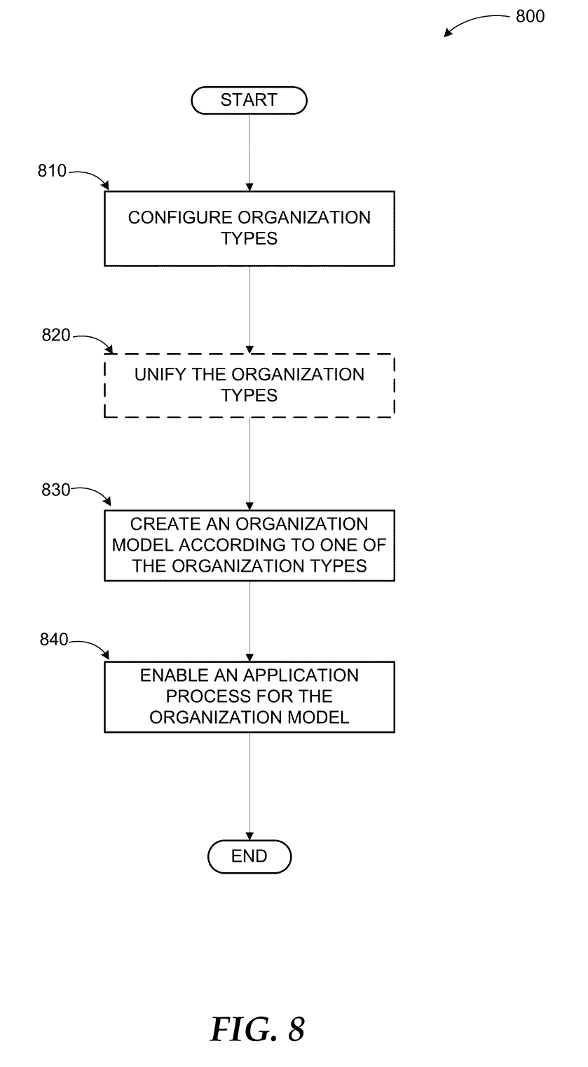

FIG. 8 illustrates a logic flow diagram for a process modeling organizational policies and processes employing the modeling application according to embodiments. Process 800 may be implemented by a modeling application in some examples.

Process 800 may begin with defining organization types at operation 810. The modeling application may structure the organization types at operation 820. The modeling application may automatically create an organization model according to one of the organization types at operation 830. Additionally, the modeling application may enable an application process for the organization at operation 840 (e.g.: standardize reporting through performance measurement dimensions).

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 800 are for illustration purposes. Employing software to model organizational scenarios and processes may be implemented by similar processes with fewer or additional steps, as well as in different order of operations using the principles described herein.

According to some embodiments, a method executed on a computing device for modeling organizational structures, policies, and processes may include configuring one or more organization types defining internal control rules for a business application; structuring an organization model according to at least one of the organization types; and enabling a business application process for the organization model according to the internal control rules defined by the at least one of the organization types. The method may further include enabling integration of performance measurement dimensions and reporting using the organization model.

According to other embodiments, the method may include enabling the business application process by standardizing the business application according to the internal control rules for using shared services and centralized organization processing, where the application domains include financials, accounting operations, and/or human resources. The internal control rules may include default internal rules, custom internal rules, and/or internal control overriding rules. The internal control rules may define performance measurement dimensions and reporting policies, and control data security by defining access parameters to data. The internal control rules may further define one or more internal control policies, data management and maintenance policies, or one or more of human resources hierarchy, legal hierarchy, operations hierarchy, security hierarchy, and reporting hierarchy. Legal hierarchy divides economic resource ownership between legal entities; operations hierarchy divides accountability for economic resources between operating units; security hierarchy divides data access privileges among internal organizations; and reporting hierarchy divides aggregated totals among organization control points.

According to further embodiments, a computing device for modeling organizational scenarios and processes, may include a memory and a processor executing a control component in conjunction with the instructions stored in the memory. The control component may configure one or more organization types defining internal control rules for a business application; structure an organization model according to at least one of the organization types; enable a business application process for the organization model according to one or more internal control rules defined by the at least one of the organization types; and standardize the business application according to the internal control rules for using shared services and centralized organization processing.

The organization model may be employed to integrate a plurality of organization processes within the business application. The business application scenario may be procurement, human resources management, and/or expense management scenarios. The control component may further restructure the organization model using date effective hierarchies and/or integrate the organization model with one or more of a global address book, a performance measurement dimension policy, a data security policy, and an internal control policy. The control component may also add one or more operating unit types to the organization model for industry specific organization concepts.

Yet other embodiments are directed to a computer-readable memory device with instructions stored thereon for modeling organizational scenarios and processes. The instructions may include configuring one or more organization types defining internal control rules for a business application; structuring an organization model according to at least one of the organization types; enabling a business application process for the organization model according to the internal control rules defined by the at least one of the organization types; integrating the organization model with at least one from a list of: a global address book, a performance measurement dimension policy, a data security policy, and an internal control policy; and adding one or more operating unit types to the organization model for industry specific organization concepts.

The instructions may further include reusing modeled hierarchies to implement other organization structures; inheriting a data management policy according to the internal control rules inherited from the at least one of the organization types; and/or implementing cost control policies according to the internal control rules.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for modeling organizational structures, policies, and processes, the method comprising:
configuring one or more organization types defining internal control rules for a business application;
structuring an organization model according to at least one of the organization types; and
enabling a business application process for the organization model according to the internal control rules defined by the at least one of the organization types.

2. The method of claim 1, further comprising:
enabling integration of performance measurement dimensions and reporting using the organization model.

3. The method of claim 1, further comprising:
enabling the business application process by standardizing the business application according to the internal control rules for using shared services and centralized organization processing.

4. The method of claim 1, wherein the application domains include at least one of: financials, accounting operations, and human resources.

5. The method of claim 1, wherein the internal control rules include at least one from a set of: default internal rules, custom internal rules, and internal control overriding rules.

6. The method of claim 1, wherein the internal control rules define performance measurement dimensions and reporting policies.

7. The method of claim 1, wherein the internal control rules control data security by defining access parameters to data.

8. The method of claim 1, wherein the internal control rules define one or more internal control policies.

9. The method of claim 1, wherein the internal control rules define data management and maintenance policies.

10. The method of claim 1, wherein the internal control rules define at least one from a set of: human resources hierarchy, legal hierarchy, operations hierarchy, security hierarchy, and reporting hierarchy.

11. A computing device for modeling organizational scenarios and processes, the computing device comprising:
a memory storing instructions; and
a processor coupled to the memory, the processor executing a control component in conjunction with the instructions stored in the memory, wherein the control component is adapted to:
configure one or more organization types defining internal control rules for a business application;
structure an organization model according to at least one of the organization types;
enable a business application process for the organization model according to one or more internal control rules defined by the at least one of the organization types; and
standardize the business application according to the internal control rules for using shared services and centralized organization processing.

12. The computing device of claim 11, wherein the organization model is employed to integrate a plurality of organization processes within the business application.

13. The computing device of claim 11, wherein the business application scenario is at least one from a list of: procurement, human resources management, and expense management scenarios.

14. The computing device of claim 11, wherein the control component is further adapted to:
restructure the organization model using date effective hierarchies.

15. The computing device of claim 11, wherein the control component is further adapted to:
integrate the organization model with at least one from a list of: a global address book, a performance measurement dimension policy, a data security policy, and an internal control policy.

16. The computing device of claim 11, wherein the control component is further adapted to:
add one or more operating unit types to the organization model for industry specific organization concepts.

17. A computer-readable memory device with instructions stored thereon for modeling organizational scenarios and processes, the instructions comprising:
configuring one or more organization types defining internal control rules for a business application;
structuring an organization model according to at least one of the organization types;
enabling a business application process for the organization model according to the internal control rules defined by the at least one of the organization types;
integrating the organization model with at least one from a list of: a global address book, a performance measurement dimension policy, a data security policy, and an internal control policy; and
adding one or more operating unit types to the organization model for industry specific organization concepts.

18. The computer-readable memory device of claim 17, wherein the instructions further comprise:
reusing modeled hierarchies to implement other organization structures.

19. The computer-readable memory device of claim 17, wherein the instructions further comprise:
inheriting a data management policy according to the internal control rules inherited from the at least one of the organization types.

20. The computer-readable memory device of claim 17, wherein the instructions further comprise:
implementing cost control policies according to the internal control rules.
